(19) United States
(12) Patent Application Publication
(10) Pub. No.: US 2018/0137301 A1
(43) Pub. Date: May 17, 2018

(54) PROXY-CONTROLLED COMPARTMENTALIZED DATABASE ACCESS

(71) Applicant: Trend Micro Incorporated, Tokyo (JP)

(72) Inventor: Jason C. AVERY, Austin, TX (US)

(73) Assignee: Trend Micro Incorporated, Tokyo (JP)

(21) Appl. No.: 15/870,335

(22) Filed: Jan. 12, 2018

Related U.S. Application Data
(63) Continuation of application No. PCT/US2015/043053, filed on Jul. 31, 2015.

(51) Int. Cl. G06F 21/62; H04L 29/06; G06F 17/30

(52) U.S. Cl. CPC G06F 21/6218; H04L 63/0281; H04L 63/105; H04L 63/0884; G06F 17/30864

(57) ABSTRACT

A technique includes controlling compartmentalized access to a database, including, in a proxy for the database, mapping a user to a set of available query resources based at least in part on at least one credential provided by the user. Controlling the compartmentalized access to the database also includes exposing the set of available query resources to the user for selection based at least in part on the mapping. The set of available query resources includes a query object. The technique includes, in response to the user selecting a query resource, using the proxy to access the database for the user based on the selected query resource and returning a corresponding result to the user.

### CROSS-REFERENCE TO RELATED APPLICATION

This application is a continuation of International Application No. PCT/US2015/043053, with an International Filing Date of Jul. 31, 2015, which is incorporated herein by reference in its entirety.

### BACKGROUND

For purposes of enhancing the retrieval and storage of large volumes of data, the data may be organized in a database. One type of database is a relational database in which data is stored in tables. In the relational database, a given table defines a relation among the data stored in the table; and relations may also exist among tables of the relational database. Another type of database is a graph database, which is based on a graph structure having nodes, properties and edges. The nodes represent entities, and the properties are pertinent information that relate to the nodes and the edges. The edges are the lines that connect nodes; and a given edge represents a relationship between connected nodes.

### BRIEF DESCRIPTION OF THE DRAWINGS

FIG. 1 is a schematic diagram of a computer system according to an example implementation.

FIG. 2 is a schematic diagram of a database proxy system according to an example implementation.

FIG. 3 is a schematic diagram of the database proxy system illustrating processing of a database query using a query engine of the database proxy system according to an example implementation.

FIG. 4 is a schematic diagram of the database proxy system illustrating processing of a query using a handler query engine of the database proxy system according to an example implementation.

FIG. 5 is a schematic diagram of the database proxy system illustrating detection of malicious intent by the system according to an example implementation.

FIG. 6 is a flow diagram depicting a technique to use a proxy to provide compartmentalized access to a database according to an example implementation.

FIG. 7 is a schematic diagram of a physical machine according to according to an example implementation.

### DETAILED DESCRIPTION

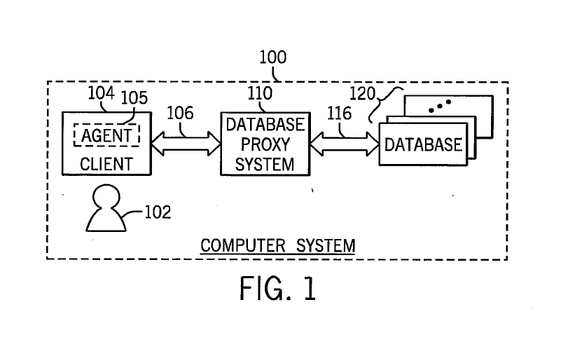

A database management system (DBMS) may employ access controls, to regulate permissions (read and write permissions, for example) for users as well as control the parts the user may access. For example, access controls may allow a given user to view individual tables of the database as well as present custom database views for the user. Referring to FIG. 1, in accordance with example implementations that are disclosed herein, instead of using access controls of a database to control compartmentalized access to the database, a computer system 100 includes a database proxy system 110, which is external to the database 120. In particular, the database proxy system 110 allows administrators to grant user-specific compartmentalized access to a set of one or multiple databases 120 without exposing sensitive data of the database 120 or the source of the information. In particular, as described herein, the database proxy system 110 allows simple to complex database queries and/or complex custom code functions to be performed with the database 120 unbeknownst to the user 102. This may be particularly advantageous for example, when the database 120 is in a production period in which a policy or change control issue related to compartmentalized user access may interrupt operations of the database 120. Because the database proxy system 110 is external to the database 120, the change may be implemented with relatively little risk.

For the example computer system 100 of FIG. 1, a user 102 may access the database proxy system 110 (for purposes of accessing the database 120) through a client 104 (a desktop computer, a thin client, a laptop computer, a tablet, a smartphone, and so forth), which may be in communication with the database proxy system 110 via network fabric 106. The network fabric 106 may be, as examples, a cellular connection, Local Area Network (LAN), Wide Area Network (WAN), Internet fabric connection, a combination of these fabrics or other fabrics. In general, the database proxy system 110 provides a database abstraction and, in general, is an intermediary service for providing access for the user 102 to one or more databases 120 in a generic way.

In accordance with some implementations, a user 102 may, via the client 104, access the database proxy system 110 via a Remote Procedure Call (RPC). In this manner, the client 104 may contain a set of machine executable instructions, or software, that forms an agent, when executed by the client 104, for purposes of serving as a local representative of remote procedure machine executable instructions of the remote procedure call. The agent 105 serves as a representative of the remote procedure and communicates a message across the network fabric 106 to initiate the RPC in the database proxy system 110. The database proxy system 110, as a result of the RPC, authenticates the user 102 and subsequently reveals to the user 102 (via communication over the network fabric 106) a list of available query resources (query resources that include one or multiple query objects and may include methods, query connects, available database operators, and so forth) that are available to the user 102 based on the user's access classification.

As an example, the query resources may include one or more database query objects that may be used by the user 102 for purposes of accessing one or multiple of the databases 120. In this manner, the database proxy system 110 may, in accordance with example of implementations, define a query template, having parameters that are passed to the proxy 110 by the user 102 for purposes of performing the query. In response to receiving these parameters, the database proxy system 110 may then execute one or multiple database operations (submit queries, execute joins, and so forth) for purposes of performing the query initiated by the user 102. These underlying operations to the database 120, in turn, are hidden or isolated, from the user 102; and moreover, the corresponding results from the database 120 may be filtered or otherwise processed before the results are returned to the user 102 via the RPC protocol.

Likewise, the database proxy system 110 may define one or multiple handler templates corresponding to generic database operations that may be initiated by the user 102, without exposing the underlying database requests/operations that are performed with the database 120 for purposes of performing the underlying functions. The database proxy system 110 may also filter or otherwise process the resulting data returned from the database 120 before communicating the results to the user 102.

Thus, the database proxy system 110 allows administrators to grant compartmentalized access to one or multiple databases 120 without additional licenses or special tools, which are created by database vendors. As depicted in FIG. 1, database proxy system 110, in accordance with example implementations, may provide a single interface to multiple databases 120, without exposing the back end database connections) to the user 102. Unlike the use of database views, modifying the access control configuration may be performed without special privileges without the database 120 being accessed or without a the use of a database server maintenance window. Moreover, the database proxy system 110 allows for custom machine executable instructions, or “code,” to be executed to perform a specific service or a set of complex database operations without the user's knowledge. Such custom code may be used to offload relatively heavy work from the database server and avoid excessive consumption of system resources on the database server.

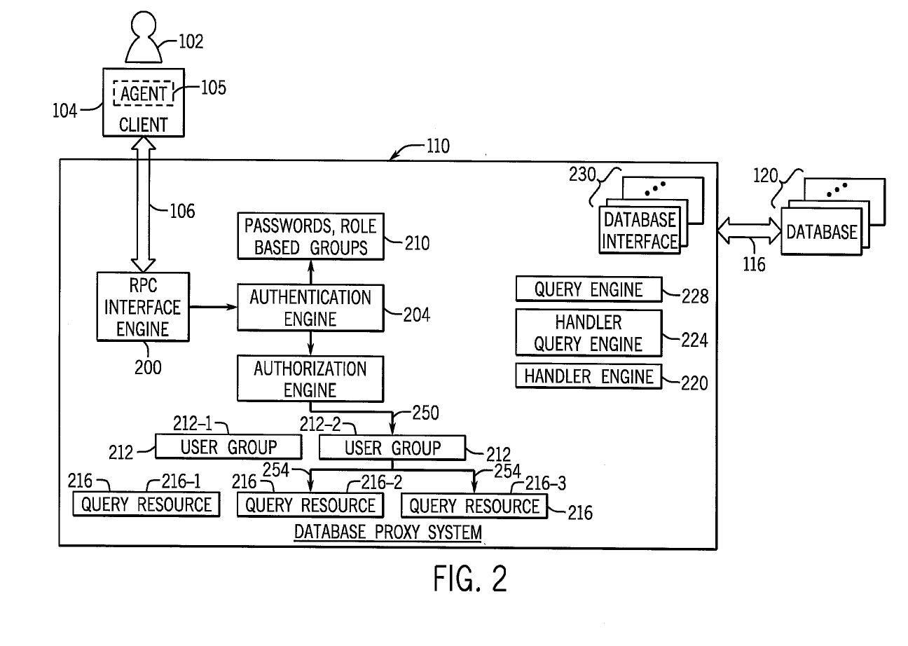

FIG. 2 depicts an example implementation of the database proxy system 110. To initiate access to a given database 120, the user 102 may communicate via the network fabric 106 with an RPC interface 200 of the database proxy system 110. In this manner, the user 102 may initiate an RPC call to the RPC interface 200 for purposes of logging into the database proxy system 110 and supplying credentials (login identification (ID), password, digital certificate, and so forth). The RPC interface 200 communicates the supplied credentials to an authentication engine 204 of the database proxy system 110. The authentication engine 204 checks the credentials against stored access information 210 (data stored in a memory of the database proxy system 110, for example) for purposes of validating supplied credentials and, in accordance with example implementations, after validation, associating the user 102 with a role-based group of users.

In this manner, in accordance with example implementations, an authorization engine 206 of the database proxy system 110 may, based on the identified user, associate the user with a particular user group 212 (example user groups 212-1 and 212-2, being depicted in FIG. 2). It is noted that although two user groups are depicted in FIG. 2, the database proxy system 110 may employ the use of more than two user groups 212, in accordance with further example implementations.

A given user group 212 may be associated with one or multiple query resource sets 216 (example query resource sets 216-1, 216-2, and 216-3, being depicted as examples in FIG. 2). Although FIG. 2 depicts three query resource sets 216, and the database proxy system 110 may use more or less than three query resource set 216, in accordance with further example implementations. For the example depicted in FIG. 2, the authorization engine 206 associates (as depicted by association mapping 250) the user 102 with the user group 212-2; and the database proxy system 110 further associates (via illustrated mappings 254 and 255) the user group 212 to query resource set 216-2 and query resource set 216-3. Thus, for the example depicted in FIG. 2, the user 102 may select and use any of the generic query resources of the query resource sets 216-2 and 216-3.

In accordance with example implementations, in response to validating the credentials that are supplied by the user 102, the authentication engine 204 returns a session identification (ID) to the user 102 (via the RPC interface 200 and network fabric 106). In this manner, the user 102 may access the query resources of the resource sets 216-2 and 216-3 via further RPC calls using the session ID, which is supplied by the authentication engine 204.

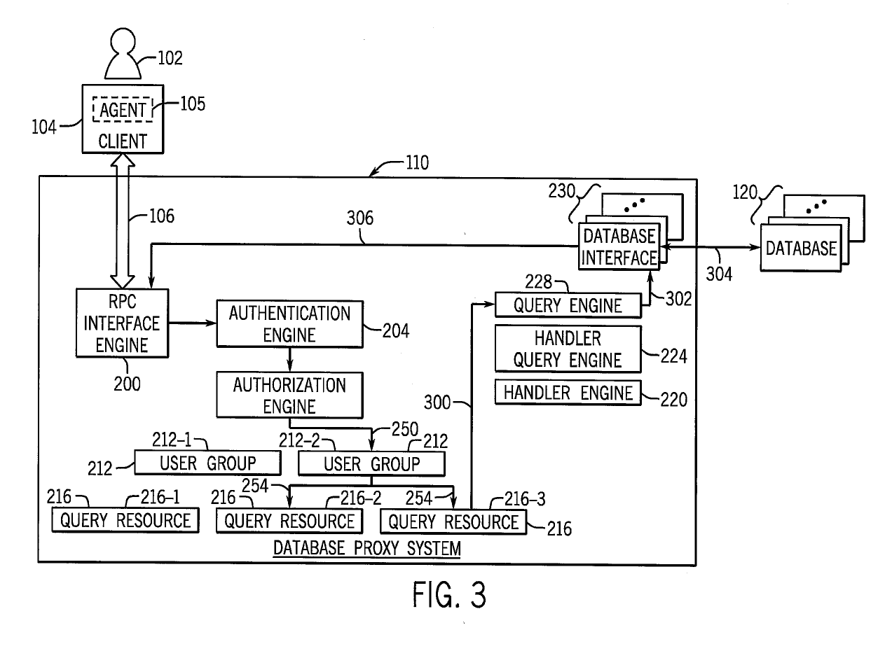

FIG. 3 illustrates operations of the database proxy system 110 for the specific example of the user 102 accessing the database 110 via use of a query of one of the query resource sets 216-2 and 216-3. For example, a particular query resource that is available for the user 102 may be a “Get_Name_By_ID” query to use the query, the user may supply one or more corresponding parameters associated with the query and supply the session ID number in the corresponding RPC call.

As illustrated by data flowpath 300, a query engine 228 of the database proxy system 110 validates the parameter(s) supplied by the user 102 with the RPC call and, via the appropriate database interface 230 of the database proxy system 110, the query engine 228 executes the corresponding database operations (indicated by data flowpath 304) with the database 120. In this manner, the query engine 228 may execute one or multiple queries and may employ the use of one or multiple database operations to restrict the data being accessed to selected tables, rows, partial rows, and so forth, depending the compartmentalized access that has been set up in association with the selected query resource template being accessed by the user 102.

As depicted by data flowpath 306, the resulting data received from the database 120 may then be communicated to the user via the RPC interface 200 and the network fabric 106. It is noted that, in accordance with example implementations, the database proxy system 110 may further filter and/or modify the result data before communicating the data to the user 102. In accordance with further example implementations, the database proxy system 110 may not modify the resulting data from the database. Thus, many variations are contemplated, which are within the scope of the appended claims.

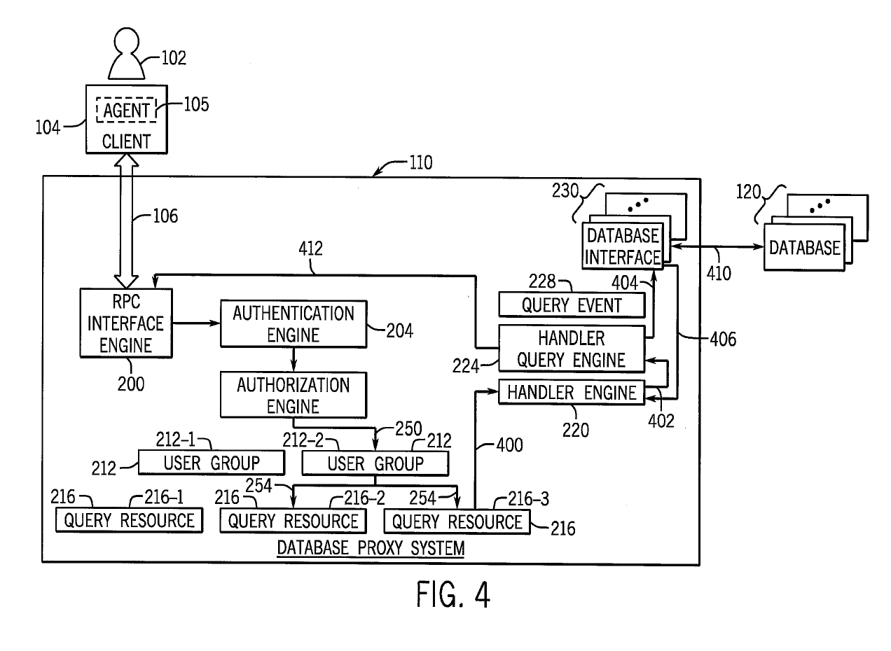

FIG. 4 depicts an illustration of operations by the database proxy system 110 in response to the user 102 selecting a handler of one of the query resource sets 216-2 and 216-3. For this example, the user 102 selects, via an RPC call with the appropriate session ID, a “Create_Name” handler and supplies the new “Name” value. As shown by data flowpath 400, a handler engine 220 of the database proxy system 110 processes the call for purposes of ensuring that the call passes intelligent data integrity checks, which are hidden from the user. As shown by data flowpath 402, in accordance with example implementations, the handler engine 220 may use a handler query engine 402 for the purpose of using queries and function combinations that are available to the handler engine 220, without these queries/functions being exposed to the user 102. After the intelligent data integrity checks are passed, the handler engine 220 creates the Name by communicating (as indicated by bidirectional data flowpaths 404 and 410) via the appropriate database interface 230 with the database 120 for purposes of retrieving the ID associated with the new name; and then the database proxy system 110 communicates the new ID value back to the user via the RPC interface 200 and network fabric 106, as shown by data flowpath 412.

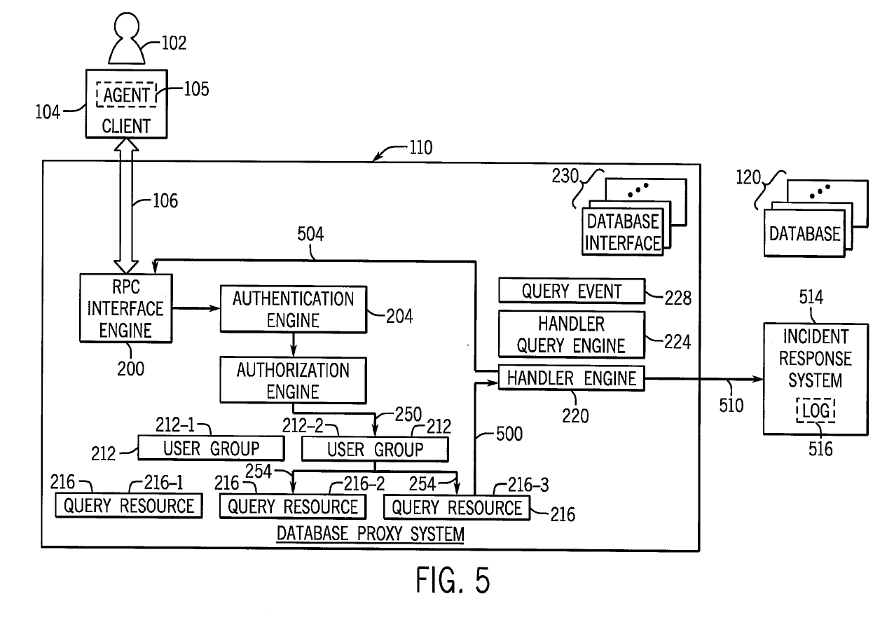

In accordance with some implementations, the database proxy system 110 may employ measures to detect malicious intent by a user or a configured compromised account. For example, a handler function of the query resource set 216-3 may be a “Set_Admin_User” function, which should not be authorized for the user 102 or any other user in user group 212-2. However, the presence of the function creates a “honey pot” for purposes of alerting personnel to a possible compromised account or a malicious intent by the user 102. Referring to FIG. 5, the user 102 may call the “Set_Admin_User” function to set a “privilege elevation,” and as depicted in FIG. 5, this call may cause the handler engine 220 to alert (as shown by data flowpath 510) an external incident response system 514 for purposes of alerting personnel to the compromised account or malicious intent. In this manner, the incident response system 514 may contain a 1 of 516 of user IDs for further analysis/inquiry by a system administrator. In accordance with example implementations, the handler engine 220 may also communicate (as shown by data flowpath 504) a “Successful” status to the user 102. Depending on the particular implementation, the database proxy system 110 may thus allow multiple actions/attempted actions by the user 102 (assuming nothing has been detected) to be logged/evaluated for purposes of allowing the system administrator to assess whether the given user really has malicious intent or whether the account has been compromised.

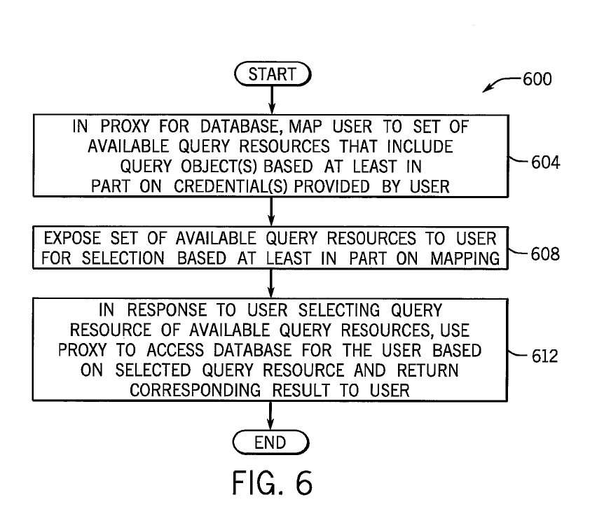

To summarize, a technique 600 that is detected in FIG. 6 may be used in accordance with example implementations for purposes of using a proxy to compartmentalize user access to a database. Pursuant to the technique 600, in a proxy for the database, the user is mapped (block 604) to a set of available query resources based at least in part on at least one credential that is provided by the user and the set of available query resources, which includes one or multiple query objects, is exposed (block 608) to the user for selection based at least in part on the mapping. Pursuant to the technique 600, in response to the user selecting a query resource of the available query resources, the proxy is used to access the database for the user based on the selected query resource and a corresponding result is returned to the user, pursuant to block 612.

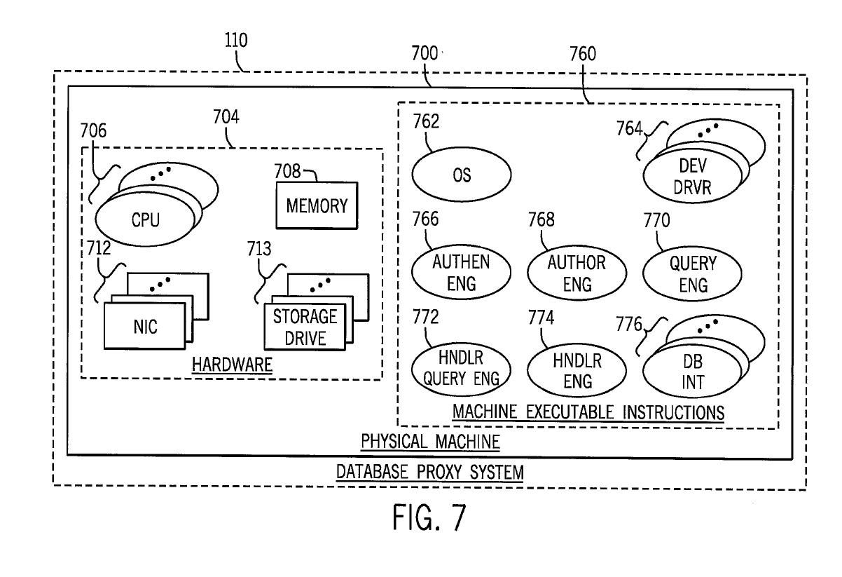

Referring to FIG. 7, in conjunction with FIG. 2, in accordance with the database proxy systems 110 may be formed at least in part by a physical machine 700. In this regard, the physical machine 700 is, an actual machine that is made up of actual hardware 704 and actual machine executable instructions, or “software.” As an example, the hardware 704 may include one or multiple Central Processing Units (CPUs) 706, one or multiple interface cards (MICs) 712, one or multiple storage drives 714, and so forth. Moreover, the hardware may also include a memory 708, such as a system memory. In general, the memory 708 is a non-transitory medium that may be formed, for example, from semiconductor devices, optical devices, magnetic storage devices, and so forth. The memory 708 may store data representing user credentials, user-supplied query parameters; query results; and so forth, depending on the particular implementation. Moreover, the memory 708 may store machine executable instructions, which are executed by one or more of the CPU(s) 706 for purposes of forming one or more components of the database proxy system 110.

In accordance with example implementations, the machine executable instructions 760 may include instructions 762 that, when executed by the CPU(s) 706 to form an operating system; instructions 764 that, when executed by the CPU(s) 706 cause the CPU(s) 706 to form one or more device drives; instructions 766 that, when executed by the CPU(s) 706 cause the CPU(s) to form the authentication engine 204; instructions 768 that, when executed by the CPU(s) 706 cause the CPU(s) 706 to form the authorization engine 208; instructions 770 that, when executed by the CPU(s) 706 cause the CPU(s) 706 to form the query engine 228; instructions 772 that, when executed by the CPU(s) 706 cause the CPU(s) 706 to form the handler query engine 224; instructions 774 that, when executed by the CPU(s) 706 cause the CPU(s) 706 to form the handler engine 220; instructions 776 that, when executed by the CPU(s) 706 cause the CPU(s) 706 to form one or multiple database interfaces 230; the CPU(s) 706 may execute instructions to form the RPC interface engine 200; and so forth.

In accordance with further example implementations, one or multiple of the engines 204, 208, 224, 228, 220, and one or multiple database interfaces 230, and the RPC interface 200 may be constructed as a hardware component that is formed from dedicated hardware components (one or more integrated circuits that contain logic that is configured to conform query processing, handler processing, and so forth). Thus, the components of the database proxy system 110, which are described herein, may take on one of many different forms and may be based partially or wholly on processor-executed software and/or dedicated hardware, depending on the particular implementation.

Other implementations are contemplated, which are within the scope of the appended claims. For example, in accordance with further example implementations, one or more components of the database proxy system 110 may be contained in a “sandbox.” In this manner, a “sandbox” refers to one or more security mechanisms that isolate in this manner, one or more components, such as the query resource sets 216, from each other and from other components. Such isolation may be used to prevent users from gaining unauthorized access to query resources, for example. As an example, a given sandbox may be formed from a relatively tightly controlled set of resources for the component to be executed, forming a sandbox that isolates the components to a given memory or disk space. As another example, a sandbox may be formed from a virtual machine. Thus, many variations are contemplated, which are within the scope of the appended claims.

While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. A method comprising:
controlling compartmentalized access to a database, comprising:
in a proxy for the database, mapping a user to a set of available query resources based at least in part on at least one credential provided by the user, wherein the set of available query resources comprises a query object;
exposing the set of available query resources to the user for selection based at least in part on the mapping; and
in response to the user selecting a query resource of the available query resources, using the proxy to access the database for the user based on the selected query resource and returning a corresponding result to the user.

2. The method of claim 1, further comprising, in the proxy, authenticating the user based at least in part on the at least one credential, wherein exposing the set of available query resources is further based at least in part on results of the authentication.

3. The method of claim 1, wherein the mapping comprises associating the user with a given user group of a plurality of user groups, and the exposing comprises revealing a set of available query resources based on the association of the user with the given user group.

4. The method of claim 1, wherein exposing the set of available query resources comprises revealing a query template and the user selecting the query resource comprises the user communicating a query method call using the query template, the method further comprising:
in response to the user calling, communicating a query based at least in part on the query method call to the database to access the database for the user; and
receiving a query result from the database in response to the query,
wherein using the proxy to return the result comprises communicating the query result to the user.

5. The method of claim 1, wherein exposing the set of available query resources comprises revealing a handler function call to the user, the handler function call being associated with machine executable instructions hidden to the user, the method further comprising:
receiving at least one value from the user for the least one parameter, executing the handler function call based at least in part on execution of the machine executable instructions; and
receiving a result from the database in response to the execution of the machine executable instructions.

6. The method of claim 5, wherein executing the handler function call further comprises communicating at least one query to the database.

7. The method of claim 1, wherein exposing the set of available query resources to the user comprises exposing at least one query resource to test whether the user is attempting unauthorized access to the database and selectively generating an alert based at least in part on use of the at least one query resource by the user.

8. The method of claim 1, further comprising using the proxy to expose query resources to at least one other database based at least in part on another mapping associated with the at least one credential.

9. A system comprising:
a database; and
a database abstraction engine to provide compartmentalized access to the database for a user, the database abstraction engine comprising:
an authentication engine to associate the user with a given predefined role of a plurality of predefined roles;
an authorization engine to:
select a group of methods for accessing the database based at least in part on the association and
expose a query object of the selected group of methods to the user to allow the user to select a given method of the plurality of methods; and
a processing engine to:
transform the selected method without exposing the transformation to the user to generate at least one database request;
communicate the at least one database request with the database; and
communicate a result of the at least one database request to the user.

10. The system of claim 9, wherein the database abstraction engine further comprises:
a remote procedure call interface to communicate remotely with a client associated with the user.

11. The system of claim 10, wherein:
the authentication engine performs a validation test on at least one credential provided by the user in a remote procedure call; and
the remote procedure call interface, in response to the validation test validating the user:
creates a session identification;
communicates the session identification to the user;
interacts thereafter with the user using at least one other procedure call; and
uses the session identification in the at least one other procedure call to identify the user.

12. An article comprising a non-transitory storage medium to store instructions that when executed by a processor-based system cause the processor-based system to:
provide a remote procedure call interface to be invoked by a first remote procedure call initiated by a user, wherein the user provides at least one credential in association with the call;
in response to the remote procedure call:
associate the user with a set of available query resources based at least in part on the at least one credential, the set of available query resources comprising a query object;
expose the set of available query resources to the user for selection; and
establish a session identification; and
in response to at least one remote procedure call associated with the session identification:
allow the user to select a query resource of the available query resources;
access the database for the user based on the selected query resource; and
return a corresponding result to the user.

13. An article of claim 12, the storage medium storing instructions that when executed by the processor-based system cause the processor-based system to:
reveal a query template to the user;
in response to the user communicating a query method call using the query template, communicate a query based at least in part on the query template to access the database for the user; and
receiving a query result from the database in response to the query.

14. An article of claim 12, the storage medium storing instructions that when executed by the processor-based system cause the processor-based system to:
reveal a handler function call to the user, the handler function call being associated with machine executable instructions hidden to the user;
execute the handler function call based at least in part on execution of the machine executable instructions; and
receive a result from the database in response to the execution of the machine executable instructions.

15. An article of claim 12, the storage medium storing instructions that when executed by the processor-based system cause the processor-based system to:
expose at least one query resource to test whether the user is attempting unauthorized access to the database and selectively generate an alert based at least in part on use of the at least one query resource by the user.
